(19) United States
(12) Patent Application Publication
(10) Pub. No.: US 2010/0140304 A1
(43) Pub. Date: Jun. 10, 2010

(54) One-piece dispensing closure

(76) Inventors: Steve Walunis, Ravenna, OH (US); Barry Michael Daggett, Austintown, OH (US)

Correspondence Address: TUROCY & WATSON, LLP, 127 Public Square, 57th Floor, Key Tower, CLEVELAND, OH, 44114, US

(21) Appl. No.: 12/314,368

(22) Filed: Dec. 9, 2008

(51) Int. Cl. B67D 3/00

(52) U.S. Cl. 222/480

(57) ABSTRACT

A one-piece dispensing closure is disclosed. The one-piece dispensing closure includes a base, a lid having a first flap and means to irreversibly attach to the base, a first living hinge connecting the base to the lid, and a second living hinge connecting the first flap to the lid. The simplistic design of the dispensing closure allows for easy production of dispensing closures of different shapes and sizes.

### FIELD OF THE INVENTION

The invention generally relates to dispensing closures and, in particular, to a one-piece closure with at least one flap for opening and closing a dispensing aperture.

### BACKGROUND

Dispensing closures for bottles, cans and other containers frequently have one or more flaps that can be pivoted between open and closed positions to conveniently dispense product from the container without removing the closure. Examples of the general type of closures under consideration here are disclosed in the following U.S. patents, the disclosures of which are incorporated herein by reference: U.S. Pat. Nos. 4,693,399, 4,936,494, 5,330,082 and 6,575,323. The dispensing closures are typically produced by an injection molding process.

There is a continuous demand, however, for dispensing closures that can be produced at low cost with better performance, less mold maintenance, faster cycle, more design flexibility and low capital expenditure.

### SUMMARY OF THE INVENTION

A one-piece dispensing closure is disclosed. The one-piece dispensing closure includes a base, a lid having a first flap and means to irreversibly attach to the base, a first living hinge connecting the base to the lid, and a second living hinge connecting the first flap to the lid. In one embodiment, the means to irreversibly attach to the base comprises a positive snap lock on the lid and a matching hole on the base. In another embodiment, the lid comprises a third living hinge connecting a second flap to the lid. In another embodiment, the lid comprises a plurality of living hinges connection a plurality of flaps to the lid. In another embodiment, the flap is maintained in a closed position by a releasable snap-bead structure at the top edge of the lid.

Also disclosed is a container assembly. The container assembly includes a container having a dispensing opening and a one-piece dispensing closure attached to the dispensing opening. The one-piece dispensing closure includes a base; a lid having a first flap, a first living hinge connecting the base to the lid, and a second living hinge connecting the first flap to the lid.

### BRIEF DESCRIPTION OF THE DRAWINGS

FIG. 1 is a perspective view of an embodiment of the one-piece dispensing closure of the present invention in a “as molded” position.

FIG. 2 is a perspective view of the one-piece dispensing closure of FIG. 1 in a fully assembled position with flaps closed.

FIG. 3 is a cut-off view of the one-piece dispensing closure of FIG. 2.

FIG. 4 is another cut-off view of the one-piece dispensing closure of FIG. 2.

FIG. 5 is a perspective view of the one-piece dispensing closure of FIG. 1 in a half-assembled position with flaps partially open.

FIG. 6 is a perspective view of the one-piece dispensing closure of FIG. 1 in a half-assembled position with flaps closed.

FIG. 7 is a perspective view of the one-piece dispensing closure of FIG. 2 in a fully assembled position with flaps open.

FIG. 8 is a bottom view of the one-piece dispensing closure of FIG. 2 showing the positive snap locks that keep the lid mated to the base.

FIG. 9 is a composite drawing showing other embodiments of the one-piece dispensing closure of the present invention.

### DESCRIPTION OF THE PREFERRED EMBODIMENTS

This description is intended to be read in connection with the accompanying drawings, which are to be considered part of the entire written description of this invention. The drawings are not necessarily to scale and certain features of the invention may be shown exaggerated in scale or in somewhat schematic form in the interest of clarity and conciseness. In the description, relative terms such as “front,” “back,” “up,” “down,” “top” and “bottom,” as well as derivatives thereof, should be construed to refer to the orientation as then described or as shown in the drawing under discussion. These relative terms are for convenience of description and normally are not intended to require a particular orientation. Terms concerning attachments, coupling and the like, such as “connected” and “attached,” refer to a relationship wherein structures are secured or attached to one another either directly or indirectly through intervening structures, as well as both movable or rigid attachments or relationships, unless expressly described otherwise.

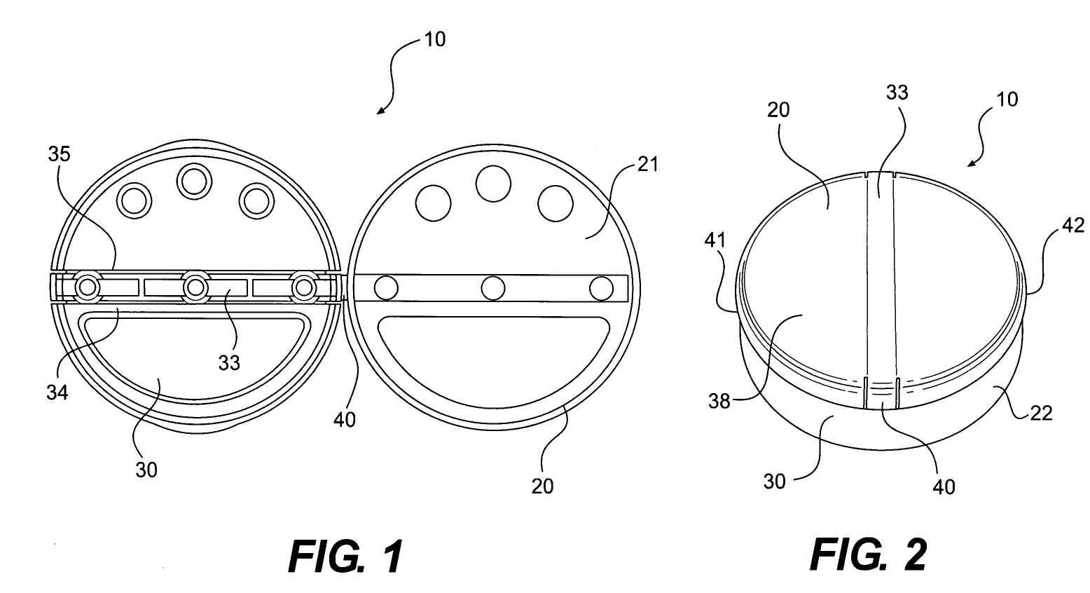

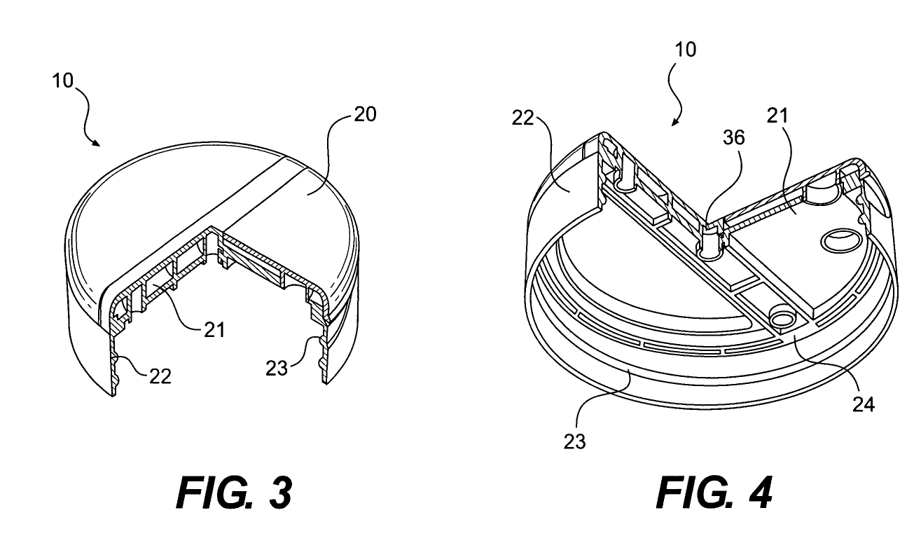

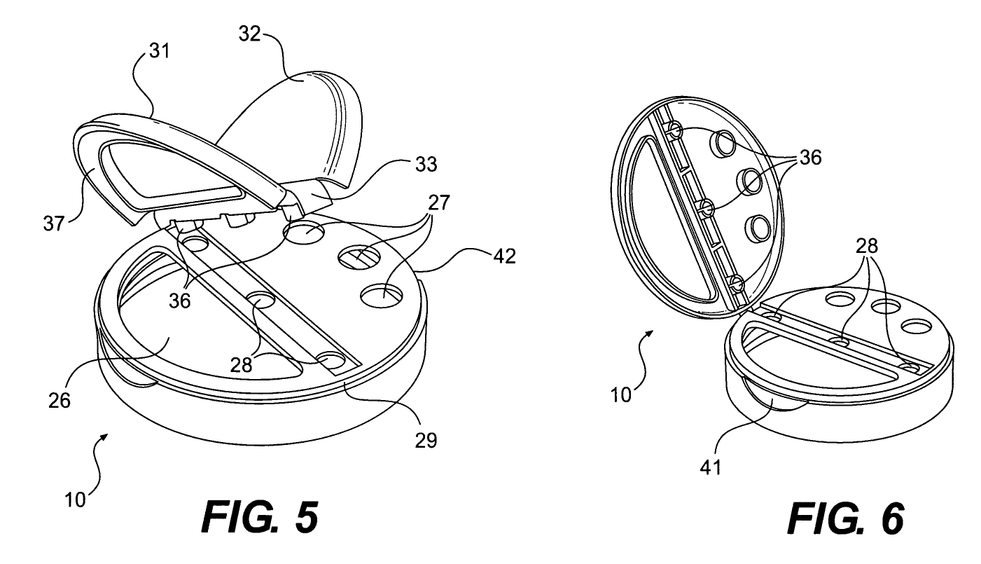

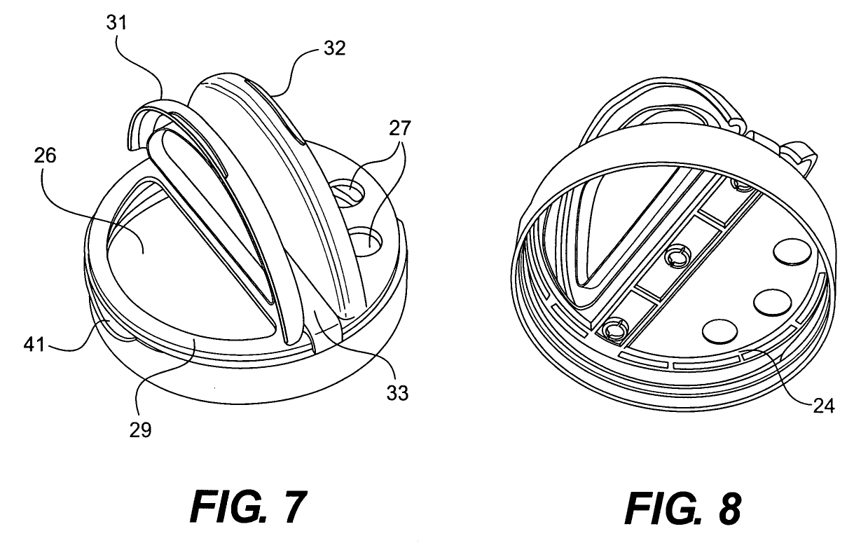

Referring now to FIGS. 1-9, there is shown a dispensing closure 10 in an embodiment of the invention. The dispensing closure 10 is a unitary or one-piece structure preferably formed of an injection molded suitable thermoplastic material such as polypropylene. The dispensing closure 10 comprises a base 20, a lid 30, a living hinge 40 that connects the base 20 to the lid 30. The term “living hinge” refers to a hinge integrally formed with two opposite portions of the same material. Typically the material along the living hinge is thin relative to the adjacent areas to facilitate flexing or bending of the opposite portions (i.e., the base 20 and the lid 30). A living hinge allows one portion to bend relative to the other portion, as would other hinges between the two portions. The living hinge 40 allows for a single piece design that can be molded as in-line of draw. No slides or sub-slides are required in the molding design.

The base 20 has a generally circular end wall 21 and a cylindrical skirt 22 depending from the periphery of the end wall. The skirt 22 is formed with internal threads 23 enabling it to be screwed onto a mouth of a container. A lower face or side of the end wall 21 includes a circumferentially continuous sealing surface 24 that registers with and can engage the mouth of a bottle or container. A removable liner (not shown) such as an induction seal liner, may be positioned in the base 20 against the sealing surface 24 prior to assembly of the dispensing closure on a bottle to assure freshness and tamper evidence by causing the liner to seal on the mouth of the container. The base 20 illustrated in FIGS. 1-6 is a two-mode design having a relatively large spoon or pouring opening 26 at one side of the end wall 21, and a plurality of sift or shake openings 27 in an opposite side of the end wall.

The lid 30 contains a pair of flaps 31 and 32. Each of the flaps 31 and 32 selectively opens and closes the pouring opening 26 and shake openings 27, respectively. The flaps 31 and 32 are connected to a chordal or diametral area 33 of the lid 30 by respective living hinges 34 and 35. The term “chordal”, as used herein, is intended to cover the special case where the area 33 is symmetrical with a diametral line such as where, as illustrated, the flaps 31 and 32 are essentially of the same size, but also includes arrangements where the flaps are of unequal size and the area is more distinctly offset from a true diametral line. In the illustrated case, the living hinges 34 and 35 are elongated elements that extend along a major portion of the chordal area 33 and the width of the respective flaps. The living hinges 34 and 35 in the illustrated embodiment are parallel to each other. The hinges 34 and 35 comprise relatively thin, small areas of material that connect the flaps 31 and 32 to the chordal area 33.

In a as-molded condition, the lid 30 is connected to the base 20 by the living hinge 40. The lid 30 is then folded towards the base 20 and is irreversibly attached to the base 20 via positive snap locks 36. The positive snap locking mechanism is well-known to one skilled in the art. As shown in FIGS. 4 and 6, the positive snap locks 36 are formed in the chordal area 33 on the back side of the lid 30. When the lid 30 is folded towards the base 20, the positive snap locks 36 enter and engage with the corresponding locking holes or slot 28 on the base 20. Once in a lock-in position, the positive snap locks 36 cannot be disengaged unless broken.

A releasable flap catch mechanism, such as the snap-bead design as illustrated, is provided to releasably hold each of the flaps 31 and 32 closed on the end wall 21 to close their respective apertures or openings 26 and 27. The snap-bead catch mechanism includes an edge 29 on the circular end wall 21 that extends slightly over the exterior wall of the cylindrical skirt 22, and a complimentary inward curvature 37 on the edge of the lid 30 that snap catches the edge 29 of the base 20 when the flaps 31 and 32 are in a closed position. The release of the flaps 31 and 32 is facilitated by thumbtabs 41 and 42 formed on the opposite sides of the cylindrical skirt 22.

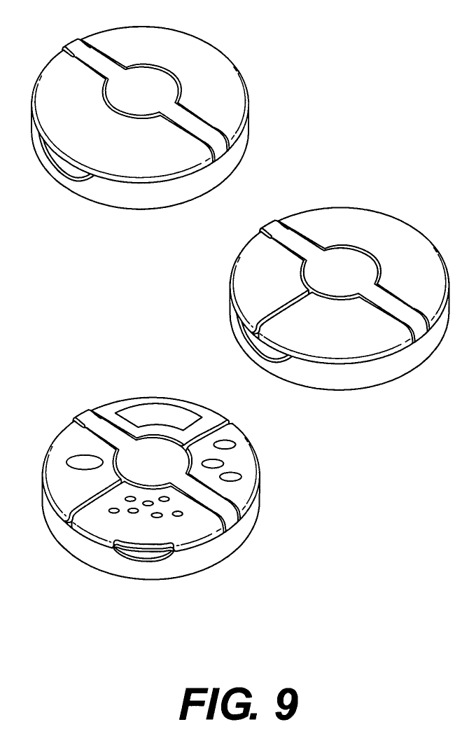

Although a two-flap design is shown in FIGS. 1-8, one skilled in the art would understand that the dispensing closure 10 can easily adopt a tri-flap or quad-flap design as shown in FIG. 9.

As shown in FIGS. 1-8, the top surface 38 of the lid 30 is free of any structure components and, therefore, can be used for displaying the company name or logo. The simplistic design of the dispensing closure 10 allows for easy production of dispensing closures of different shapes and sizes. The living hinge design allows for less stress during the molding process, which may be further simplified by using modular tooling. In addition, since product will be flexed during the in-mold closing step before it is ejected from tool, the hinges will always be flexed at the same time, thus eliminating the variance with a lag in time until lid is actually closed.

Also disclosed is a container assembly. The container assembly includes a container having a dispensing opening and a one-piece dispensing closure attached to said dispensing opening. The one-piece dispensing closure includes a base; a lid having a first flap, a first living hinge connecting the base to the lid, and a second living hinge connecting the first flap to the lid.

In one embodiment, the one-piece dispensing closure is reversibly attached to the container.

In another embodiment, the one-piece dispensing closure is irreversibly attached to the container.

In another embodiment, the lid further includes a second flap connected to the lid by a third living hinge.

In another embodiment, the lid further includes attaching means to irreversibly attach the lid to the base.

In a related embodiment, the attaching means includes a positive snap lock on the lid and a matching hole on the base.

In another embodiment, the base includes an end wall with at least one opening on the end wall and a skirt extending downward from the periphery of the end wall.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. For example, the invention, besides being employed with screw-on caps such as disclosed herein, can also be employed with friction or adhesive retained or snap-on closures that fit on or in a container. Accordingly, the patent is not to be limited in scope and effect to the specific embodiments herein shown and described nor in any other way that is inconsistent with the extent to which the progress in the art has been advanced by the invention.

What is claimed is:

1. A one-piece dispensing closure, comprising
a base;
a lid comprising a first flap;
a first living hinge connecting said base to said lid; and
a second living hinge connecting said first flap to said lid.

2. The one-piece dispensing closure of claim 1, wherein said lid further comprises attaching means to irreversibly attach said lid to said base.

3. The one-piece dispensing closure of claim 2, wherein said attaching means comprises a positive snap lock on said lid and a matching hole on said base.

4. The one-piece dispensing closure of claim 1, wherein said base comprises
an end wall with at least one opening on said end wall; and
a skirt extending downward from the periphery of said end wall.

5. The one-piece dispensing closure of claim 4, wherein said base further comprises a snap-bead structure at a top edge of said skirt and wherein said first flap comprises a complimentary inward curvature on an edge that, in a closed position, snap catches said snap-bead structure.

6. The one-piece dispensing closure of claim 5, wherein said base further comprises a thumbtab on said skirt to facilitate the release of said first flap from said closed position.

7. The one-piece dispensing closure of claim 4, wherein said skirt comprises internal threads.

8. The one-piece dispensing closure of claim 4, wherein said end wall comprises a pouring opening and a plurality of shake openings, wherein said pouring opening is larger than said shake openings.

9. The one-piece dispensing closure of claim 1, wherein said lid further comprises a second flap connected to said lid by a third living hinge.

10. The one-piece dispensing closure of claim 9, wherein said first flap and said second flap are or the same size and shape.

11. The one-piece dispensing closure of claim 9, wherein said first flap and said second flap are or the different size.

12. The one-piece dispensing closure of claim 9, wherein said lid further comprises a third flap connected to said lid by a fourth living hinge.

13. The one-piece dispensing closure of claim 12, wherein said lid further comprises a fourth flap connected to said lid by a fifth living hinge.

14. A container assembly, comprising:
a container having a dispensing opening; and
a one-piece dispensing closure attached to said dispensing opening, comprising:
a base;
a lid comprising a first flap;
a first living hinge connecting said base to said lid; and
a second living hinge connecting said first flap to said lid.

15. The container assembly of claim 14, wherein said one-piece dispensing closure is reversibly attached to said container.

16. The container assembly of claim 14, wherein said one-piece dispensing closure is irreversibly attached to said container.

17. The container assembly of claim 14, wherein said lid further comprises a second flap connected to said lid by a third living hinge.

18. The container assembly of claim 14, wherein said lid further comprises attaching means to irreversibly attach said lid to said base.

19. The container assembly of claim 18, wherein said attaching means comprises a positive snap lock on said lid and a matching hole on said base.

20. The container assembly of claim 14, wherein said base comprises
an end wall with at least one opening on said end wall; and
a skirt extending downward from the periphery of said end wall.
